(19) United States
(12) Patent Application Publication
(10) Pub. No.: US 2026/0274448 A1
(43) Pub. Date: Sep. 17, 2026

(54) FLEXIBLE HEAT PIPE

(71) Applicant: Government of the United States as represented by the Secretary of the Air Force, Wright-Patterson AFB, OH (US)

(72) Inventor: Jonathan Allison, Albuquerque, NM (US)

(21) Appl. No.: 19/045,161

(22) Filed: Feb. 4, 2025

(51) Int. Cl. B64G 1/50; F28D 15/02; F28D 15/04

(52) U.S. Cl. CPC B64G 1/506; F28D 15/0241; F28D 15/046

(57) ABSTRACT

A flexible heat pipe. The flexible heat pipe has an evaporator portion and a condenser portion joined to the evaporator portion by a flexible portion. The flexible portion is a metal corrugated hose with radial corrugations and axial corrugations.

### GOVERNMENT INTEREST

The invention described herein may be manufactured and used by or for the Government of the United States for all government purposes without the payment of any royalty.

### FIELD OF THE INVENTION

The embodiments herein generally relate to heat pipes, and more specifically to high heat transport capacity flexible heat pipes.

### BACKGROUND

A heat pipe is a heat-transfer device that employs phase transition to transfer heat. At a condenser portion of a heat pipe, a volatile fluid inside the heat pipe and in contact with a thermally conductive solid surface turns into a vapor by absorbing heat from that surface. The vapor then travels along the heat pipe to a cold interface at a condenser portion and condenses back into a liquid, releasing the latent heat. The liquid is wicked back to the hot surface through capillary action and the cycle repeats. In general, heat pipes can move heat with less temperature drop than by conduction through solid materials.

Flexible heat pipes can find use in heat transfer applications requiring mechanical flexibility. For example, robotic spaceflight can benefit from heat pipes facilitating heat transport across hinge lines and gimballed interfaces. Additionally, flexible heat pipes could be beneficially utilized in spaceflight, including space capsules, spaceplanes, and space stations. A flexible heat pipe could be used within a crew cabin and could offer reconfigurability as may be needed if a space vehicle installs new experiments or encounters an emergency.

However, in general, flexible heat pipes to-date have very poor heat transport capacity. Known flexible heat pipes can be too heavy for most space applications. Existing flexible heat pipes have poor heat transport capacity because of the nature of the flexible wicks that they use for capillary fluid transport from the condenser portion to the evaporator portion. Existing flexible wicks have relatively poor porosity to liquid flow which hinders the ability of existing flexible heat pipes to move heat.

A continuing, unaddressed need exists for systems and methods to achieve a flexible heat pipe with improved wicking for capillary fluid transport.

### BRIEF DESCRIPTION OF THE DRAWINGS

The embodiments herein will be better understood from the following detailed description of the drawings, in which:

FIG. 1 is a representative flexible heat pipe;

FIG. 2 is a cross-sectional view of Section 2-2 in FIG. 1;

FIG. 3 is a cross-sectional view of Section 3-3 in FIG. 1;

FIG. 4 is a diagram depicting a representative axial corrugation process;

FIG. 5 is a cross-sectional view of Section 5-5 in FIG. 4;

FIG. 6 is a cross-sectional view of Section 6-6 in FIG. 4;

FIG. 7 is a cross-sectional view of Section 7-7 in FIG. 4;

FIG. 8 is a diagram depicting a representative axial corrugation process using an internal mandrel;

FIG. 9 is a cross-sectional view of Section 9-9 in FIG. 8;

FIG. 10 is a cross-sectional view of Section 10-10 in FIG. 8;

FIG. 11 is a cross-sectional view of Section 11-11 in FIG. 8;

FIG. 12 is a diagram depicting a representative axial corrugation process;

FIG. 13 is a cross-sectional view of Section 13-13 in FIG. 12;

FIG. 14 is a side view of an axially corrugated metal pipe;

FIG. 15 is an end view of an axially corrugated metal pipe;

FIG. 16 is a side view of an example process for making radial corrugations;

FIG. 17 is a schematic diagram of an example process for making radial corrugations;

FIG. 18 is a schematic diagram of an example process for making radial corrugations;

FIG. 19 is a side view of an example process for making radial corrugations;

FIG. 20 is a schematic diagram of an example process for making radial corrugations;

FIG. 21 is a schematic diagram of an example process for making radial corrugations;

FIG. 22 is a side view of an axially and radially corrugated metal pipe;

FIG. 23 is an end view of an axially and radially corrugated metal pipe;

FIG. 24 is side view of a connection between a flexible portion and a condenser portion of a flexible heat pipe;

FIG. 25 is a cross-sectional view of Section 25-25 of FIG. 24;

FIG. 26 is a schematic diagram of a flexible heat pipe utilizing a hinge; and

FIG. 27 is a diagram of a space vehicle system utilizing a flexible heat pipe.

### DETAILED DESCRIPTION

Embodiments of the disclosed development, its various features, and the advantageous details thereof, are explained more fully concerning the non-limiting embodiments that are illustrated in the accompanying drawings and detailed in the following description. Descriptions of well-known components and processing techniques are omitted to not unnecessarily obscure what is being disclosed. Examples may be provided, and when so provided are intended merely to facilitate an understanding of how the invention may be practiced and to further enable those of skill in the art to practice its various embodiments. Accordingly, examples should not be construed as limiting the scope of what is disclosed and otherwise claimed.

The flexible heat pipe disclosed herein provides passive heat transport that satisfies the needs of applications requiring mechanical flexibility. Needs include robustness to handling, a high degree of reconfigurability, and safety when used for human-proximate applications. The flexible heat pipe disclosed herein provides for installation flexibility, deployment flexibility, and reconfiguration flexibility. Compared to other heat pipes, the flexible heat pipe provides benefits for space vehicles. For example, the flexible heat pipe disclosed herein provides solutions for facilitating heat transfer across hinge lines and gimballed interfaces for deployable radiators in space.

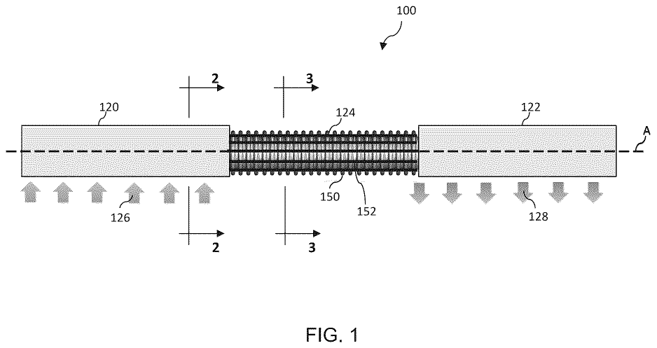

Referring to FIG. 1 there is shown a representative flexible heat pipe 100. The flexible heat pipe 100 has an evaporator portion 120 and a condenser portion 122 separated by a flexible portion 124. Heat 126 to be moved is transferred into the flexible heat pipe 100 in the evaporator portion 120 to cause a phase change in an internally disposed working fluid, e.g., vaporization to a gas phase, within the flexible heat pipe 100. Heat 128 to be released exits at the condenser portion 122 where the working fluid undergoes the reverse phase change, e.g., condensation back into a fluid. The fluid is then transported back, such as wicking by capillary transport, to the evaporator portion of the flexible heat pipe 100 to absorb additional heat. In the flexible heat pipe 100, the evaporator portion 120 and the condenser portion 122 can each be made of rigid metal and can include structural characteristics common to known rigid heat pipe configurations. In an example embodiment, the flexible heat pipe 100 can be generally cylindrically shaped and extend longitudinally about an imaginary central axis A. In other embodiments, portions of the flexible heat pipe 100, such as the evaporator and/or condenser section(s) can have flat sides or flanges that facilitate mounting to surfaces of objects from which heat is transferred.

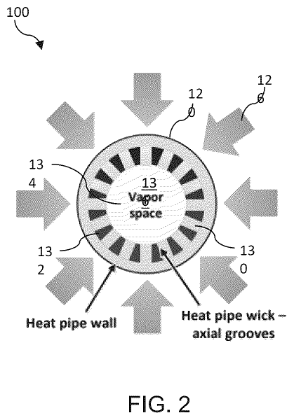

To achieve wicking from the condenser portion 122 to the evaporator portion 120, the flexible heat pipe 100 relies on capillary fluid flow. An example flexible heat pipe 100 structure to achieve capillary fluid flow in the condenser or evaporator portions is shown in the cross-sectional view of FIG. 2, which shows an axial “ridge and groove” configuration. As depicted in FIG. 2, which is a view of Section 2-2 at the evaporator portion 120 of the flexible heat pipe 100 of FIG. 1 but can be identical to that of the condenser portion 122, the flexible heat pipe 100 can have internally extending axial ridges 130 defining axial grooves 132. The axial ridges and grooves can be oriented in a longitudinal direction generally parallel to the central axis A and can be manufactured according to known means, including by extrusion of metal through a dies, and/or machining. The axial grooves 132 can be sized and shaped according to known means to serve as capillary channels suitable to move the working fluid 134 via capillary action from the condenser portion 122 to the evaporator portion 120. The working fluid 134 is disposed in the interior portion 136 of the flexible heat pipe 100 and is in fluid communication with the evaporator portion 120 and the condenser portion 122.

Upon heat 126 being transferred into the flexible heat pipe 100 at the evaporator portion 120, the working fluid 134, which can be water, for example, vaporizes in the interior portion 136 of the flexible heat pipe 100. At the condenser portion 122, heat is released as the working fluid 134 condenses back to a fluid within the axial grooves 132 defined by the axial ridges 130. As depicted in FIG. 2, a cylindrical-shaped flexible heat pipe can transfer heat 126 substantially uniformly over the entire exterior surface of the flexible heat pipe 100. Water can be safely used in human spaceflight applications. Other heat pipe fluids can be used, particularly for robotic spaceflight applications, including methanol, ethanol, and ammonia.

In an embodiment the flexible heat pipe 100, including the flexible portion 124, can be made entirely or in part of metal, e.g., copper, aluminum, titanium, and/or stainless steel, and the parts can be unitary, or separately joined, such as by welding. The flexible heat pipe 100 can be generally cylindrically shaped and can be any length, diameter, and size suitable for the desired heat transfer application. The flexible heat pipe 100 can be generally straight along its entire length or curved along a portion of their length. The configuration of size and shape of the flexible heat pipe 100 can be determined to achieve the desired heat transfer, and/or configuration determined by space constraints.

A technical challenge is presented with duplicating the axially oriented ridge and groove structure in the flexible portion 124 for wicking fluid transport inside the flexible heat pipe 100. Past attempts at achieving wicking in flexible heat pipes include providing metal wire screen mesh or a bundle of metal wires in a radially corrugated metal tube. The radial corrugations allow for flexibility, but screen mesh or metal wicks tend to have poor porosity which gives poor overall performance and limits the applications for which such flexible heat pipes can be employed. Further, for flexible heat pipes, screen mesh or sintered metal wicks are ordinarily disposed through the central core of the heat pipe. This placement creates an obstruction and a mixing up and of the regions in which liquid and vapor are carried when transitioning between rigid and flexible regions of the flexible heat pipe, thus reducing the heat transport.

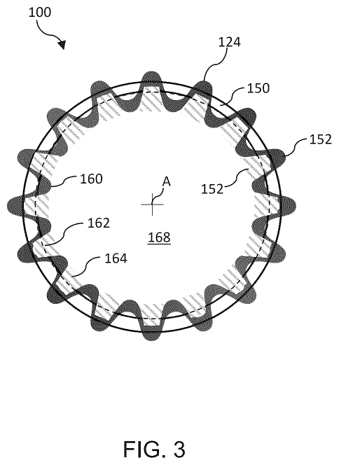

Referring now to FIG. 3 there is shown a schematic representation of a cross-sectional view of Section 3-3 of FIG. 1. The flexible portion 124 of the flexible heat pipe 100 can be flexible and provide for the functional equivalent of axial ridges defining axial grooves in the interior 168 of the flexible heat pipe 100. In an embodiment, the flexible portion is a flexible metal pipe or hose (the terms being interchangeable and synonymous for this disclosure). As also shown in FIG. 1, the flexible portion 124 is a flexible metal hose with both radial corrugations 150 and axial corrugations 152. The radial corrugations 150 provide for bending flexibility of the flexible heat pipe 100. The axial corrugations 152 define the functional equivalent of the axial “ridge and groove” configuration of the evaporator and condenser portions described above. Internal corrugation peaks 160 define the functional equivalent of ridges that define internal valleys 162 that define the functional equivalent of axial grooves 132. Capillary fluid transport indicated by the shading at 164 transports fluid from the condenser portion of the heat pipe to the evaporator portion.

In an embodiment, as shown in FIG. 1, the entire length of the flexible portion 124 includes radial corrugations and axial corrugations. In an alternative embodiment, the entire length of the flexible portion includes axial corrugations, but only a portion of the flexible portion includes radial corrugations. Thus, the flexible portion 124 of the flexible heat pipe 100 provides for wicking of a working fluid by corrugation peaks 160 oriented parallel to the central axis A that define valleys 162 that are likewise oriented parallel to the central axis A. By “oriented parallel” to is not meant exactly parallel, but generally parallel in that each valley can correspond to a groove to provide uninterrupted fluid wicking from the condenser portion to the evaporator portion generally in the direction of the central axis A.

In a representative embodiment, the flexible portion 124 of the flexible heat pipe 100 has the same number and spacing of valleys and grooves as the evaporator or condenser portions. In this manner, an unbroken wicking path can extend from axial grooves 132 in the condenser portion 122 to the grooves of the evaporator portion 120 of the flexible heat pipe 100.

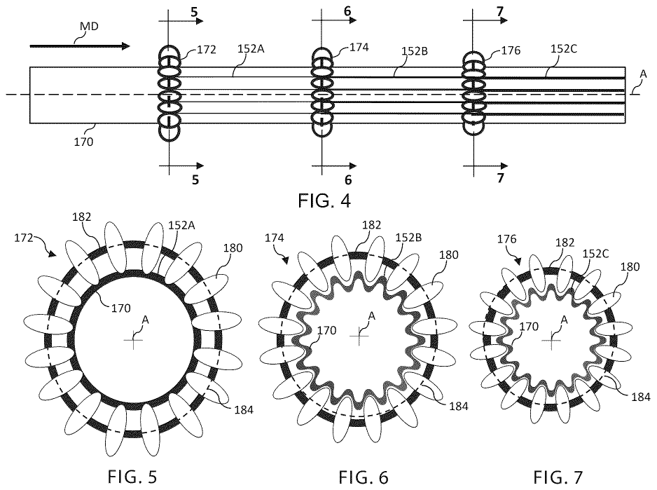

Referring now to FIG. 4-7 there is shown a representative embodiment of a method of manufacture of the flexible portion 124 of the flexible heat pipe 100. A generally circular cylindrical metal tube or pipe 170 can be moved axially in a machine direction MD into one or more stationary axial corrugation stations. In FIG. 4 three axial corrugation stations are shown: a first axial corrugation station 172, a second axial corrugation station 174, and a third axial corrugation station 176. The number and placement of axial corrugations stations can be determined and modified based on the material of pipe 170 and the desired number, size, and shape of the corrugation peaks 160 and valleys 162.

Each axial corrugation station includes a plurality of evenly distributed, annularly placed corrugation forming members 180. Each of the corrugation forming members 180 can be in substantially uniform pressure-inducing contact with the pipe 170 in the region of a desired axial corrugation. The corrugation forming members 180 can be evenly distributed annularly about pipe 170 on a generally circular forming member support 182. The number and spacing of the corrugation forming members 180 determine the number and spacing of the resulting axial corrugations 152 in the pipe 170.

Corrugation forming members 180 have a hardness and surface smoothness sufficient to cause deformation of the pipe 170 as the pipe passes in the machine direction MD through the axial corrugation stations. With each successive axial corrugation station, the corrugation forming members 180 can be configured in increasingly smaller circumferential configurations to further deform regions of the pipe 170 into axial corrugations. In an embodiment, the second and succeeding forming members 180 can be distributed on a circular forming member support 182 having a diameter less than that of the previous axial corrugation station. Alternatively, the diameters of each circular forming member support 182 can remain constant, and the size and/or shape of the corrugation forming members 180 can be sufficiently designed to effectively decrease the working diameter of the forming member to deform the axial corrugations more deeply with each successive axial corrugation station. In an embodiment, the corrugation forming members 180 are rigid rollers that roll about an axis 184 aligned with the corrugation forming member 182. The rigid roller corrugation forming members 180 can be metal, including hardened steel with a circumferential shape suitable for deforming the pipe 170 in the desired shape of the axial corrugations 152. Other process steps and apparatuses can be utilized, such as hydroforming, including hydroforming at elevated temperatures, with hydroforming jets performing the deformation function. Further, heat treatments, such as annealing, can be utilized to produce a desired temper state.

Referring to FIGS. 4-8, the pipe 170 is moved in the machine direction MD and encounters the first axial corrugation station 172. As shown in FIG. 5, which is a cross-sectional view of Section 5-5 of FIG. 4, corrugation forming members 180 contact the pipe 170 and exert pressure on the surface of pipe 170 to begin deformations of the axial corrugations 152A. As shown in FIG. 6, which is a cross-sectional view of Section 6-6 of FIG. 4, the second axial corrugation station 174 further deforms the pipe 170 to form more pronounced axial corrugations 152B. As shown in FIG. 7, which is a cross-sectional view of Section 7-7 of FIG. 4, the last, and in the illustrated embodiment last, the third axial corrugation station 176 to deform the pipe 170 to form the final structure of axial corrugations 152C. During the process of forming axial corrugations, it may be beneficial to provide intermediate annealing and or heat treatment steps to reform the metal crystals, relax internal stresses, and/or reduce the risk of rupture in subsequent forming steps. As mentioned, a heat treatment process can permit the pipe material to be returned to a preferred temper state prior to and subsequent forming steps.

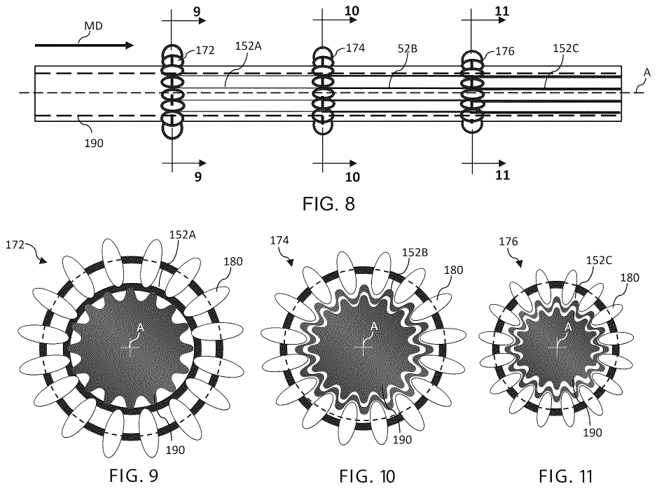

Referring to FIGS. 8-11, a process in all aspects the same as that described with reference to FIGS. 4-8 is shown, but with the addition of an internal mandrel 190. In the example process illustrated in FIGS. 8-11, the interior support mandrel 190 is utilized to provide interior support of the pipe 170 during the axial corrugation forming process. The pipe 170 is moved in the machine direction MD and encounters the first axial corrugation station 172. As shown in FIG. 9, which is a cross-sectional view of Section 9-9 of FIG. 8, in addition to the corrugation forming members 180 externally contacting the pipe 170, an interior support mandrel 190 supports the interior wall of the pipe 170 to prevent undesired collapse or deformation in regions between the corrugation forming members 180. The interior support mandrel 190 can have a cross-sectional shape, as shown in FIGS. 9-11 that corresponds to the desired shape of the axial corrugations 152. In a sense, the corrugation forming members 180 of the plurality of axial corrugation stations act as a forming die in concert with the interior support mandrel 190 to, in effect, mold the wall of the pipe 170 into axial corrugations 152.

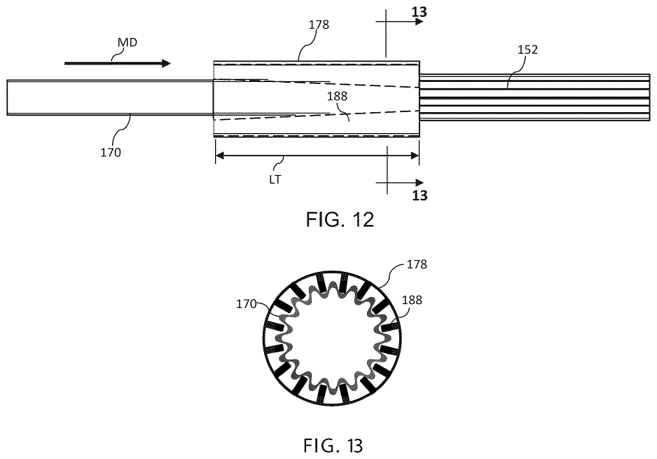

Referring to FIGS. 12-13 there is shown another embodiment of a method for producing the axial corrugations. In the illustrated method, a pipe 170 is moved in the machine direction MD into a stationary forming station 178. The forming station 178 has a plurality of tapered ribs 188 extending interiorly and which engage and gradually deform the surface of the pipe as it continues in the machine direction. As shown in the cross-sectional view of FIG. 13, which is a view of Section 13-13 of FIG. 12, the number of tapered ribs can be predetermined based on the number of desired peaks and valleys of the axial corrugations. The length LT of the tapered vanes, the angle of taper, and the maximum interior penetration can be predetermined and utilized depending on the desired structure of the peaks and valleys of the axial corrugations. And internal mandrel and/or hydraulic pressures, as discussed above, can also be utilized with the forming station 178.

Various alternative methods can be employed in the production of axial corrugations in a flexible portion of a flexible heat pipe. The pipe 170 material can be selected for thickness, ductility, tempering properties, and alloy composition. Lubricants can be utilized at the axial corrugation stations to minimize frictional forces between the corrugation forming members 180 and the pipe 170 wall. Additionally, instead of, or in combination with, the interior support mandrel 190, hydraulic forces can be employed for support of the interior walls of the pipe.

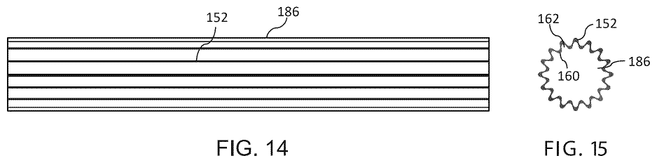

FIGS. 14 and 15 show example side elevation and end views, respectively, of an axially corrugated pipe 186 with axial corrugations 152 including internal corrugation peaks 160 that operate as the functional equivalent of ridges that define internal valleys 162 that operate as the functional equivalent of grooves 132.

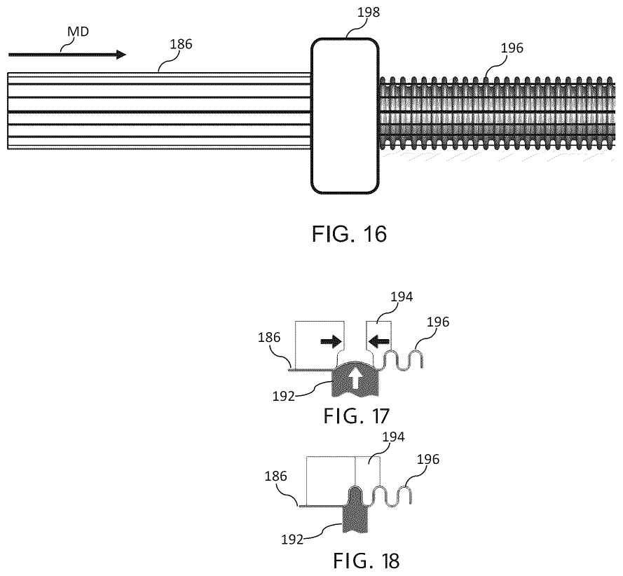

Referring now to FIGS. 16-18 there is shown a representative process for forming the radial corrugations 150 on the flexible portion 124. In general, known methods and processes for forming radial corrugations can be utilized, including hydroforming. In the embodiment illustrated, the axially corrugated pipe 186 is moved in the machine direction MD into a hydroforming radial corrugator 198. As indicated schematically at FIG. 17, the hydroforming radial corrugator 198 grabs a section of the axially corrugated pipe 186, expands it without torsion using high pressure water 192, while simultaneously feeding the tube in axially from both directions, and crimped by crimping blocks 194 to form a radial corrugation, as indicated at FIG. 18. After corrugating a section, more axially corrugated pipe 186 is moved into the hydroforming radial corrugator 198, and the radially and axially corrugated pipe 196 exits. as indicated. The radially and axially corrugated pipe 196 can be joined to an evaporator and a condenser as the flexible portion of the flexible heat pipe 100.

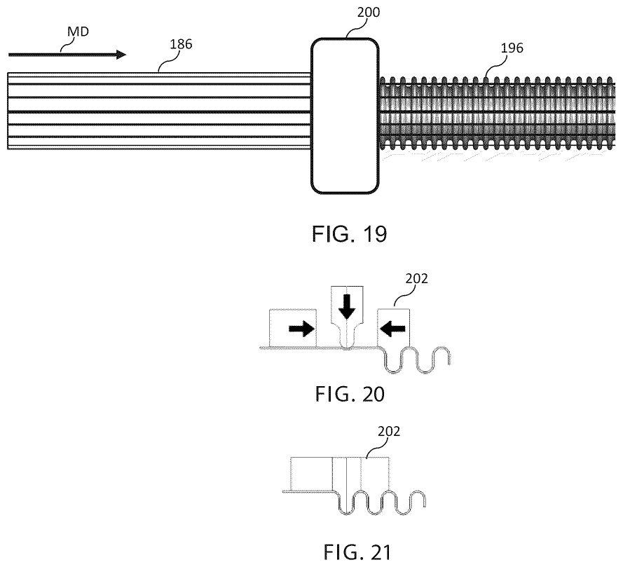

Referring now to FIGS. 19-21 there is shown another representative process for forming the radial corrugations 150 on the flexible portion 124. In the embodiment illustrated, the axially corrugated pipe 186 is moved in the machine direction MD into a crimp forming corrugator 200. As indicated schematically, the crimp forming method grabs a section of the axially corrugated pipe 186, compresses it without torsion using a shutter-crimp blocks 202 in a sequence as indicated at FIGS. 20-21, while simultaneously compressing the section of pipe in the crimp forming corrugator 200 axially from both directions. After radially corrugating a section, more axially corrugated pipe 186 is moved into the crimp forming corrugator 200, and the radially and axially corrugated pipe 196 exits. as indicated. The radially and axially corrugated pipe 196 can be joined to an evaporator and a condenser as the flexible portion of the flexible heat pipe 100.

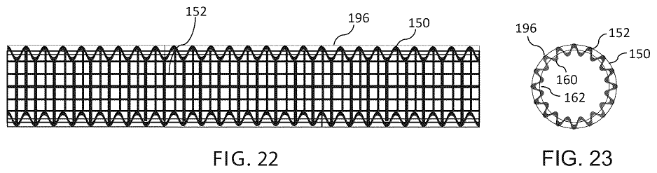

FIGS. 22 and 23 show example side elevation and end views, respectively, of an axially and radially corrugated metal pipe 196 with radial corrugations 150 for flexibility and axial corrugations 152 including internal corrugation peaks 160 that operate as the functional equivalent of ridges, and which define internal valleys 162 that operate as the functional equivalent of grooves 132.

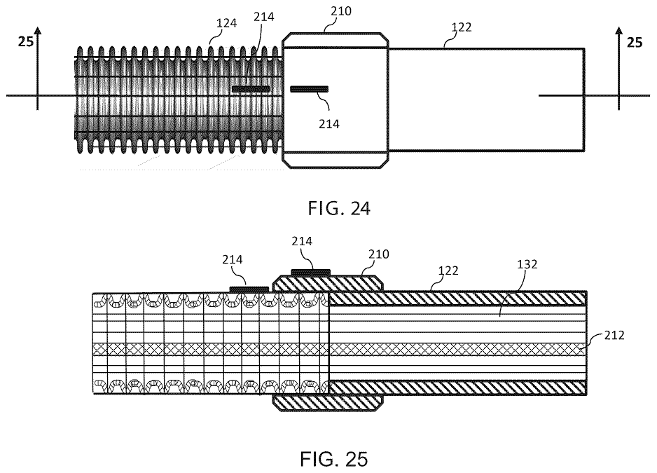

Referring now to FIG. 24, an example embodiment is shown for how the evaporator portion and the condenser portion of the heat pipe can be secured in operational relationship to the flexible portion. FIG. 24 shows the condenser portion 122 of the flexible heat pipe 100 joined to the flexible portion 124 by a fitting 210. Fitting 210 can be secured by any suitable means, including by welding to both the condenser portion 122 and the flexible portion 124. As indicated in the cross-sectional view of FIG. 25, which is a view of Section 25-25 of FIG. 24, it can be beneficial for the axial grooves 132 of the condenser portion 122 to line up in axial alignment with the valleys 162 of the axial corrugations 152 of the flexible portion 124. One exemplary groove/valley continuous fluid path 212 is indicated with cross-hatching in FIG. 25. To ensure that grooves and valleys align, alignment features 214 can be disposed on the fitting 210 and the flexible portion 124, or other suitable location. Alignment features 214 can be visually or tactilely discernable marks or ridges.

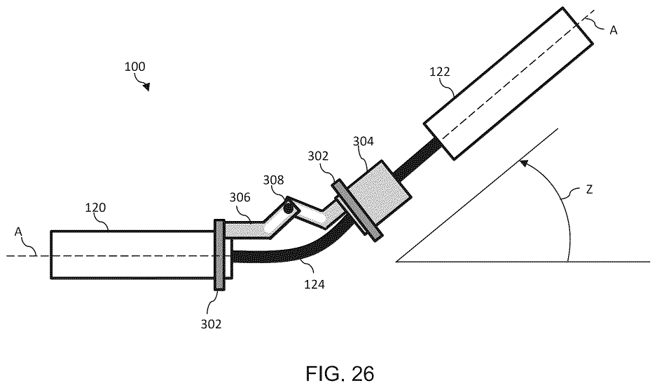

Referring now to FIG. 26, there is shown schematically an example device for prescribing a range of motion to the flexible heat pipe 100. As shown, one or more optional braces 300 can be connected to the flexible heat pipe 100 to limit the range of bending to a maximum angle Z and/or to prevent kinking of the heat pipe, and/or to secure a bend into a set configuration. In an embodiment, the brace 300 is adjustably hinged and can be adjusted and set to prescribe a range of motion to bending in a single plane. The brace 300 can be mounted to either or both of the evaporator portion 120 or the condenser portion 122. In the illustrated embodiment, the brace 300 is mounted to the evaporator portion 120 by a locking collar 302. the locking collar 302 can be a “revolution collar” which includes a rotatable ring mounted at or near the rigid end of, for example, the evaporator portion 120. Controlled rotation of the revolution collar can be achieved by being fitted into a cylindrical groove disposed at the connection location to allow 360-degree rotatable positioning around the rigid connection component to define the plane of bending. Revolution collars can include locking mechanisms, such as cam locks, to prevent the hinge from revolving while in an operational configuration.

In an embodiment, a collar 302 can be mounted to the each of the evaporator portion 120 and the condenser portion 122, and the brace 300 can be joined to both collars. In another embodiment, as shown in FIG. 26, one collar can be joined to one of the evaporator portion 120 or the condenser portion 122, and the other collar can be positioned to constrain the range of motion of the flexible portion 124 directly via a rigid tube support 304. The brace 300, which can include multiple linked components, such as slide joints 306 provides for adjustability of the brace 300 joined in flexible and/or rotatable attachment and can be locked in place after installation via a threaded knob 308. Hinge points may be either simple hinges or they may be a slider hinge on one or both leaves of the hinge. Slider hinges provide adjustability of the hinge point which enables the flexible heat pipe to be bent and/or secured in wider or narrower bends, as required.

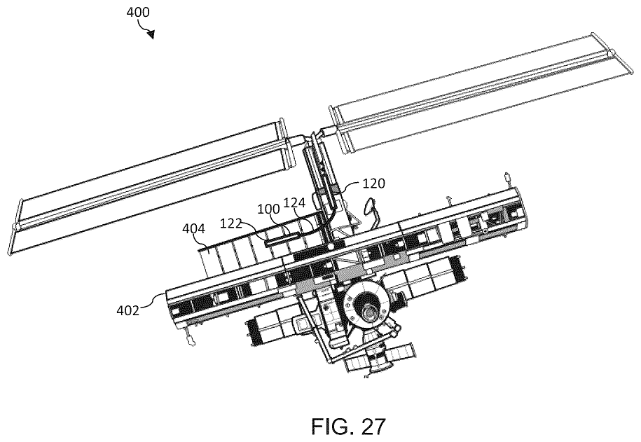

Referring now to FIG. 27, there is shown a space heat transfer system 400 for transferring heat from a first thermally functional object to a second thermally functional object. By “thermally functional” as used herein is meant an object or space from which or two which heat is desired to be transferred. In the illustrated embodiment, a space vehicle 402 is, or contains, a first thermally functional object, and a deployable radiator 404 is a second functionally thermal object. A flexible heat pipe 100 as described herein facilitates heat transfer from the body of the space vehicle 402, or from an object or space in the space vehicle, to the deployable radiators 404. The evaporator portion 120 can be in heat transfer contact with the body of the space vehicle 402, or a body or space inside the space vehicle, and the condenser portion 122 can be in heat transfer contact with the radiator 404. The flexible portion 124 is connected across hinge lines and gimballed interfaces between the evaporator portion 120 and the condenser portion 122 as described herein to complete the flexible heat pipe 100.

Various optional and alternative configurations are contemplated withing the scope of the disclosure. For example, burst disks and/or dump tanks can be included in the use application of the flexible heat pipe to maintain in-flight human safety against over pressurization risks. Overwraps (such as Kevlar) and overbraids (such as commonly used around metal flex hose) can provide additional protection against puncture risks and rupture risks. The number of flexible heat pipes joined in series can be adjusted to provide flexibility in more degrees of freedom.

The foregoing description of the specific embodiments describes the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Those skilled in the art will recognize that the embodiments herein can be practiced with modification within the spirit and scope of the appended claims.

What is claimed is:

1. A flexible heat pipe, comprising,
an evaporator portion;
a condenser portion joined to the evaporator portion by a flexible portion; and
wherein the flexible portion is a metal corrugated hose with radial corrugations and axial corrugations.

2. The flexible heat pipe of claim 1, wherein the evaporator portion comprises a first plurality of internal axial grooves and the condenser portion comprises a second plurality of internal axial grooves, and further wherein the flexible portion comprises internal axial valleys 3. The flexible heat pipe of claim 1, wherein the evaporator portion comprises a first plurality of internal axial grooves and the condenser portion comprises a second plurality of internal axial grooves, and further wherein the flexible portion comprises internal axial valleys, and the evaporator portion is joined to the flexible portion by a fitting with the first plurality of internal axial grooves and the internal axial valleys in axial alignment and the condenser portion is joined to the flexible portion by a fitting with the second plurality of internal axial grooves in axial alignment with the internal axial valleys.

4. The flexible heat pipe of claim 1, wherein the heat pipe further comprises a central axis and the first plurality of grooves and the second plurality of grooves are oriented in axial alignment with the central axis.

5. The flexible heat pipe of claim 1, wherein the evaporator portion and the condenser portion are each joined to the flexible portion by a welded fitting.

6. The flexible heat pipe of claim 1, wherein the evaporator portion and the condenser portion are each joined to the flexible portion by a welded fitting, and further wherein the welded fitting has an alignment feature.

7. A space vehicle system, comprising,
a space vehicle comprising a first thermally functional object and a second thermally functional object, the second thermally functional object being deployed from and connected to the first thermally functional object; and
a flexible heat pipe, the flexible heat pipe comprising a flexible portion, wherein the flexible portion is a metal corrugated hose with radial corrugations and axial corrugations, and further wherein the flexible portion is joined to an evaporator portion in heat transfer contact with the first thermally functional object and a condenser portion in heat transfer contact with the second thermally functional object.

8. The space vehicle system of claim 7, wherein the evaporator portion comprises a first plurality of internal axial grooves and the condenser portion comprises a second plurality of internal axial grooves, and further wherein the flexible portion comprises internal axial valleys.

9. The space vehicle system of claim 7, wherein the evaporator portion comprises a first plurality of internal axial grooves and the condenser portion comprises a second plurality of internal axial grooves, and further wherein the flexible portion comprises internal axial valleys, and the evaporator portion is joined to the flexible portion by a fitting with the first plurality of internal axial grooves and the internal axial valleys in axial alignment and the condenser portion is joined to the flexible portion by a fitting with the second plurality of internal axial grooves in axial alignment with the internal axial valleys.

10. The space vehicle system of claim 7, wherein the flexible heat pipe further comprises a central axis and the first plurality of grooves and the second plurality of grooves are oriented in axial alignment with the central axis.

11. The space vehicle system of claim 7, wherein the evaporator portion and the condenser portion are each joined to the flexible portion by a welded fitting.

12. The space vehicle system of claim 7, wherein the evaporator portion and the condenser portion are each joined to the flexible portion by a fitting, and further wherein the fitting has an alignment feature.

13. The space vehicle system of claim 7, wherein the space vehicle comprises a body and a radiator, and wherein the first thermally functional object is in thermally conductive relationship to a portion of the body and the second thermally functional object is in thermally conductive relationship to a portion of the radiator.

14. The space vehicle system of claim 13, wherein the radiator is in a hinged connection to the body, and the flexible portion of the flexible heat pipe traverses the hinged connection.
